(19) United States
(12) Patent Application Publication
(10) Pub. No.: US 2010/0269312 A1
(43) Pub. Date: Oct. 28, 2010

(54) Slide fastener assembly and method of attachment

(76) Inventors: Phillip Roger Wagner, New Smyrna Beach, FL (US); Straun Sumner Wagner, New Smyrna Beach, FL (US); Martha Tipton Wagner, New Smyrna Beach, FL (US)

Correspondence Address: Phillip R Wagner, P O Box 1953, New Smyrna Beach, FL, 32170, US

(21) Appl. No.: 12/763,202

(22) Filed: Apr. 19, 2010

Related U.S. Application Data
(60) Provisional application No. 61/212,923, filed on Apr. 17, 2009.

(51) Int. Cl. A44B 19/34; A44B 19/26; A44B 18/00; A44B 99/00; F16B 33/00

(52) U.S. Cl. 24/400; 24/381; 24/305; 24/301; 411/366.1; 24/306

(57) ABSTRACT

A slide fastener assembly and method of attachment allows for simple installation or replacement of molded slider assemblies, metal zipper assemblies, or both or either halves of separating zipper assemblies. A cohesive fastener is attached to the leading edges of surfaces where a slide fastener is connected. A corresponding cohesive fastener is attached to either surface of a zipper tape of a slider assembly. The slider assembly is pressed together with corresponding cohesive surfaces where the slide fastener is to be connected, holding the slide fastener securely in place. In another embodiment, a slide fastener is manufactured with cohesive material that is integral to the zipper tape. In another embodiment, a slide fastener is attached by connection means to a band, which is connected to an outer perimeter of a frame and inner perimeter of a panel.

This application claims the benefit or, and priority to US Provisional Patent Application Ser. No. 61/212,923, filed on Apr. 17, 2009 and entitled “CONVERTIBLE AND PORTABLE INFLATABLE SPORTS GAME FRAME”, which is incorporated herein by this reference.

### BACKGROUND

1. Field of Invention

This invention relates to a slide fastener assembly and attachment method for joining two or more parts of a surface, specifically a method for easily installing, repairing or replacing either or both parts of a slide fastener or attaching a slide fastener, and associated appendages, so that the slide fastener assembly is easily removable and re-attachable, or replaceable.

2. Background

Devices which interconnect, interlock, attach or join two surfaces or two separate pieces of flexible materials are known. These include, but are not limited to, zippers, buttons, snaps, buckles, hook and loop devices (Velcro), and bungees, as well as molded plastic ridged seal closures, such as those used on “Ziploc” bags. All of these types of fasteners are widely used with various types of fabrics, canvas, vinyl, plastics, and other flexible and rigid materials.

Buttons, snaps, buckles and other types of single point fastening devices have limitations. Proper alignment is required for the two parts to join correctly. Buttons or snaps may be damaged or become disengaged, rendering the closure unworkable until a repair is made. These individual fasteners, as well as bungee attachment systems, are all very time consuming to deploy. Also, a degree of manual dexterity is required, which may be a disadvantage for people with certain disabilities as well as for those wearing gloves.

Hook and loop systems such as those produced under the trade name Velcro, are a common fastening method. Although hook and loop fasteners have considerable utility, these systems also have several significant disadvantages. The force necessary to effect disengagement is directly related to the strength of the connection and therefore excessive force may be required to effect disconnection, especially when the Velcro surfaces that are attached are wide or long. Precise register of the connection is difficult to achieve, especially when long lengths are used, and precise alignment is required. The texture of the exposed surface may cause discomfort or skin irritation. Repetitive use tends to weaken the connecting fibers. In addition to the above, many people find the sound of disengagement to be objectionable and irritating. And in some applications, such as in tactical clothing, the sound of the disengagement, while opening pockets or separating components, may be dangerous, such as when military or law enforcement personnel have a need to conceal their locations.

Zippers are well known, and variations of the device have been recorded in many patents. Two rows of metal, plastic, or nylon teeth interlock when the attached sliding pull tab transverses the aligned teeth to open or close the fastener.

Zippers can be used in a multiplicity of applications, since the many variations available offer an exceptionally versatile closure method. Zippers are available in a variety of materials, lengths, and colors. They can be “closed end” or “separating” and can be operated from either or both ends with one or more pull tabs. Zippers can be sewn into curves, circles or other shapes. Zippers can be attached to a variety of substrates such as fabric, canvas, vinyl, and flexible surfaces, among others. Attachment is usually done by sewing, but zippers can also be adhered by rivets, staples, glue, hot air welding, RF welding or other methods.

Zippers are widely used in many types of clothing, especially pants, skirts, dresses and coats. In these applications, the zipper acts as both a closure and “fitting” device, in which the zipper application itself holds the garment to a certain shape and size.

Zippers are also extensively used in purses, tote bags, backpacks, computer bags and luggage. In these applications, zippers operate as a closure device to keep contents secure, contained, and protected.

Zippers are particularly useful in large items such as tents or protective enclosures, where their main function is quick and easy entry and exit, as well as to attach adjoining sections or panels. Large partitions can also be connected and expanded by the use of zippered segments.

The inflatable industry uses zippers in the manufacturing process for various functions, such as openings for inflation and deflation, as well as an attachment method for parts and components. Zippers are used extensively by manufacturers of large inflatable movie screens, as an attachment method for integrating the projection surfaces into the inflatable frames. Zippers are preferred over other attachment methods in this application, since proper alignment and placement in a frame is critical for a smooth and wrinkle free appearance. And since a projection surface can be extremely large, 30 feet wide or more, a quick and secure attachment method is preferred.

One skilled in the art can attach zippers to a stretchable projection screen fabric with a method that thereby creates a smooth, taut viewing surface. This is done by stretching the fabric a predetermined amount while sewing or attaching the fabric to the zipper. When this process is used around the perimeter of a projection screen or other type of display panel, and the panel is then integrated into a rigid or inflated frame, the fabric or panel remains flexible, yet taut and wrinkle free.

Zippers have considerable merit as a quick, secure and easy to use fastening and closure device, as one can see from the descriptions of the many functions and applications noted above.

Bags or containers constructed of flexible plastic or polyethylene, which use a plastic molded extruded ridged seal closure assembly are known in prior art. A plastic slider system seals the closure across the top of an opening. This type of container or sealable bag is known by the trade name of “Ziploc”, among others.

Although traditional zippers could be utilized as closures on these types of bags or containers, most utilize a type of plastic slider closure. These closures are preferable to zippers in this use, since plastic slider closures provide a more water and air tight seal. There is no corrosion or rusting of the plastic fastener parts, as can occur with a metal zipper. Also, there is no concern for injury with plastic slider closures, as there may be with zippers, if a finger or other body part were to be caught in the zipper teeth.

Sealable plastic containers are useful in many applications, such as food storage, storage for clothing and textiles, or containing like quantities of small objects such as screws or buttons. Since most are constructed of clear plastic, or a similar material, contents are visible through the bag or container. The bags are available in a variety of sizes. The bags are easily opened and resealed by pressing the adjacent sides firmly together or by the use of a plastic slider mechanism to join the sides.

The bags are of a flexible construction which allows the bags and associated contents to fit in places where boxes or other rigid containers may not fit, such as under beds. Larger sizes, which also incorporate cut out handles for ease of carrying, can be used to transport or store clothing, toys, or craft supplies among other items.

The bags can also provide water-resistant storage for electronic equipment, such as cell phones and cameras, when used in aquatic environments.

The food industry has recently adapted packaging to include a reclosable system for items such as block cheese, produce such as grapes, and other items that are packaged in flexible bag type containers.

Combining the above attributes with the additional advantages that resealable bags are very inexpensive, readily available, and disposable, it is easy to see why they are a popular option for everything from sandwiches to blankets.

As noted above, clothing, luggage, and bags of all types, as well as many other items, are more functional when zippers or plastic slider closures are incorporation into the design. However, these types of sliding closures also have an elemental disadvantage. When any part of a zipper malfunctions or fails, the zipper is often rendered dysfunctional over its entire length and usually must be wholly replaced. Although the cost of a replacement zipper may be negligible; the time and effort expended to remove and replace a zipper may render the repair cost exorbitant, and prolonged.

When a plastic slider closure fails, generally the item is discarded. Items currently manufactured using plastic closures are relatively inexpensive and easily replaceable. Prior art does not disclose any method of repair of these types of closure systems, nor of offering replacement parts for plastic slider closures.

However, when a zipper becomes dysfunctional, it may be desired to have a method for repair or replacement, so that the item does not have to be discarded.

Zippers may become damaged or ineffective in many ways. Extraneous materials or nearby fabric can readily impair the fastener. Dirt or debris may cause the teeth to be inoperable. Damage or exposure to sun, water or corrosion may weaken the components and prevent proper operation. Breakage of the zipper pull, end stop, or splitting of the zipper coil can occur at any time, or over time, simply due to use and wear.

New zipper tolerances are tight and precise to ensure proper closing action. When a damaged or worn slider does not push the chain halves together precisely, the teeth are prevented from engaging one another. With repeated use, a slight widening of critical slider gaps in the two separate planes can occur, causing problems.

When a zipper becomes damaged, the item in which it is incorporated is very likely to become unusable, or ineffective for the intended use. For example, when a zipper is used in a door opening on a tent, and the zipper fails, the door either will not open, or will not close. If a zipper is used as a closure in a shroud or shield for protection of an item, failure of the zipper may result in the item being unprotected.

In some items, a zipper may be replaced fairly easily and inexpensively. In a piece of clothing, for instance, zippers are relatively short, easy to access, and can be removed and replaced by someone skilled in the art of sewing. However, in large items, or items of complex construction, zipper replacement may be difficult, prohibitively costly, or even impossible. Replacement of an item may be more cost effective than removing and replacing a zipper, since generally when one or more parts become damaged, the zipper is likely to be inoperable over the entire length and must be replaced in its entirety. Therefore, the item may become permanently obsolete.

Accordingly, there is a need for a method of installing zipper assemblies that will permit quick, easy and relatively inexpensive replacement of a zipper or associated attached parts, if any part of a zipper is damaged or fails. Previously, no solution to this problem has been presented.

### DESCRIPTION OF PRIOR ART

While zippers are prevalent in many inventions and are very useful for their intended applications, prior art does not provide for a quick, easy, and reliable repair method.

U.S. Pat. No. 7,621,581 to Wiegel (2009), “Portable vehicle and/or equipment storm shield”, discloses how zippers are used for joining large sections of material, as well as providing a means for openings in the panels. The described shields are used to cover large objects such as helicopters and tanks from the elements, in harsh desert conditions. If any one of the zippers were to fail, the entire shield would be ineffective, since the opening created by the failed zipper would allow the elements to penetrate the shield. No method or reference to zipper repair or replacement is cited.

U.S. Pat. No. 6,865,852 to Gower (2005) “Flexible wind abatement system” discloses flexible panels, some of which are connected with zippers to provide wind protection to a structure, such as a mobile home or trailer. If any of the zippers were to malfunction, the structure would be vulnerable to damaged during an adverse weather event. Flaps are described which may be used to cover the zippers to provide a level or protection from damage. However, no method of zipper repair or replacement is disclosed.

U.S. Pat. No. 5,368,085 to Ruparelia (1994) “Reusable insulating sheath for windows” discloses a vinyl window covering, which is attached over a window opening to reduce or eliminate air leakage or drafts. The covering incorporates a zipper to allow for ventilation when desired. However, if the zipper were to fail, the sheath would be ineffective in the intended purpose of sealing the opening. Again no means or mention of zipper repair is divulged.

U.S. Pat. No. 5,749,134 to Zemitis (1998) “Slide fastener repair system” discloses a complex method for repairing a zipper that is inoperable due to a faulty slide mechanism. The tedious process involves forming a gap in the zipper teeth, removing the slide fastener through the opening, positioning a replacement slider on the teeth of the zipper at the opening, and attaching a slider stop at the opening. The resulting gap is then concealed by a metal cover plate attached with a nut and bolt. The procedure is not only complicated, it requires specialized parts. The functionality of the zipper is also compromised as a result of the repair, since the result decreases the length of the zipper and the cover plate assembly is unsightly and cumbersome.

Various manufacturers have attempted to address the problem, but without an effective solution. Ameri-Brand Products Inc. markets a dome product designed to cover items such as swimming pools. The dome construction incorporates zippers as a closure method. Instructions for “Dome Zipper Replacement” are included with the product. The zipper replacement method outlined is intricate and problematical. It involves carefully cutting the damaged zipper away from the dome fabric with scissors or a razor blade, and attaching a replacement zipper using a series of snaps to fasten the replacement zipper to the dome. Male snaps are installed during the manufacturing process adjacent to the zipper tape, and female snaps are attached to the replacement zipper tape. Installing the replacement zipper appears to be a tedious and time consuming process. Proper zipper function may be affected and is subject to exact realignment of the replacement parts. Given that the male snaps are pre-installed during the manufacturing process, it is clear that zipper failure is anticipated and widespread.

Many types of tents utilize zippers for window and door apertures. Since tents are used in a variety of weather conditions and possible harsh environments, proper zipper function is crucial for a tent to serve the intended purpose of a dry enclosed shelter. Getoutdoors.com acknowledges that, “perhaps the most annoying repair is a broken zipper. Tent zippers have the unenviable job of having to zip in circles or arch under incredible stress from the tent. When a zipper blows, it is hard to repair”. Clearly, a broken zipper can spoil the intended relaxing experience that a camping trip is meant to be; as well as resulting in the need to replace the tent, which may be costly.

ZRK Enterprises offers a “zipper rescue kit” at www.zipperrescue.com. Available parts include zipper pulls and stops, and replacement zippers. If the needed repair requires anything other than a slider pull or bottom stop, the entire zipper must be removed and replaced.

Although zipper repair is problematic, zippers continue to be used extensively in many varied types of industries. Clearly, the fundamental advantages of a zipper are well known and realized in the garment industry, as well as by manufacturers of luggage, purses, and backpacks. However, zippers are also widely used a range of diverse and specialized applications.

Companies that produce and sell inflatable outdoor movie frames, such as Open Air Cinema and Epic Outdoor Cinema utilize separating zippers to fasten projection screens into inflatable frames. Typically, one zipper half is sewn to a flap, which is sewn into the inflatable frame structure and the other zipper half is sewn to a removable projection surface. The corresponding zipper halves are attached precisely to the perimeters of each of the two separate parts. When the zippers are engaged on all four sides, the projection screen is drawn straight, and in alignment. This installation method is simple and quick.

An alternative method of attachment of the projection screen to the frame entails the use of bungee cords. The cords are used to connect pairs of grommets on the projection screen and the inflatable frame together. A disadvantage of the bungee attachment method is that the grommet/cord attachment points must be very close together. Spacing of 6 to 8 inches around the entire perimeter is necessary to pull the surface taut and wrinkle free. The sheer number of attachment points, on screens that can be up to 30 feet wide or greater, makes it very time consuming to install or remove the projection surface with this method.

Other screen manufacturers, such as Draper and Da-Lite, also use bungee type cords to attach projection surfaces to their large fixed frames, which consist of assembled truss, pole, or other rigid frame structures. Again, the close spacing of the bungee attachment points makes the installation of the projection screen extremely slow and tedious.

However, the disadvantage with the use of zippers in the inflatable industry has been that if any of the zipper segments that are permanently attached to the perimeter of a frame are damaged, generally it is less expensive to replace the entire frame structure rather than retrofit a costly repair of the zipper components incorporated into the frame structures.

In view of the information presented, it can be appreciated that there exists a need for a method to facilitate a simple, quick, and cost effective system for the installation and/or replacement of zippers. The method disclosed may also be used for the installation or modification of a plastic slider closure assembly on items for which a plastic closure is preferred. Accordingly, the present invention substantially fulfills this need.

### Objects and Advantages

In order for the examiner to fully appreciate the objects and advantages of the present invention, a brief summary of the invention and the method that allows for quick and easy installation, repair, or replacement of an entire zipper assembly, or either half of a separating zipper, or a plastic slider closure assembly follows.

The method entails the attachment of Velcro, or any other cohesive self engaging material, or pressure sensitive adhesive tape, to the two leading edges of the surfaces where the zipper or plastic closure is to be connected. Corresponding Velcro or adhesive tape is attached to both surface areas of the zipper tape, adjacent to the zipper slider, or on the flanges of a plastic closure. The zipper or plastic closure can then be aligned and attached to the corresponding Velcro, or adhesive fastened onto the surface of the material, securely holding the zipper or plastic closure in place.

Alternatively, the invention discloses zipper tape which can be manufactured with a Velcro-type textile that is integral to the zipper assembly. When the zipper tape is constructed of a material such as “Omni-tape”, which is a snag free, self-engaging Velcro type material with hook and loop components both woven on the same surface, the zipper tape can be mated with either hook or loop Velcro, or another surface of Omni-tape.

Alternatively, a band or other section of material can be added between a zipper and the surface to which a zipper is to be attached or joined. Utilizing Velcro on the edges of a band, as well as on the edge of the zipper tape to be attached, and to an outer surface, allows for the addition of or removal of a band for expansion, reduction, or re-sizing of an object.

The drawing sheets and detailed descriptions will expand on the brief summary of the invention presented above.

When the invention is utilized with a plastic closure, the plastic slider closure can be attached by either a pressure sensitive adhesive tape or by a Velcro type cohesive fastener. A cohesive fastener such as 3M Dual Lock tape would be advantageous for this purpose. This self mating tape is clear, has a low profile, as well as an aggressive adhesive backing. The Dual Lock tape adheres to many substrates including polypropylene, polyethylene, metal, finished wood and among others. The integrated, mushroom shaped tops allow the tape to lock together, but can also be easily peeled apart.

By applying adhesive or self mating tape to the top edges of an open plastic bag or other container and to the corresponding edges of a slider closure system, and joining the two surfaces together, any plastic bag can be retrofitted with a sealable opening.

Whether the resealable closure is attached by adhesive tape or a cohesive removable tape, the result is a container that is more versatile, desirable and user friendly. For example, pre-packaged food found on store shelves, such as potato chips and cereal, have no closure method incorporated into the packaging. In order to re-close the bag, the consumer has to find a suitable means such as a wire tie or a device such as a clothes pin or clip. It is important to secure the top of the bag to retain the freshness of the contents, as well as keeping the contents contained. A consumer can simply fold the bag over, but obviously the fold will disengage and the contents will become stale or contaminated.

By attaching a resealable closure, the bag will be sealed with the contents secured and can be reopened and re-sealed numerous times. The closure becomes part of the bag and is always attached, unlike a clip or wire tie.

Some types of plastic bags are manufactured continuous on a roll, giving the user the ability to cut them to various lengths. Bags are cut and heat sealed, forming the bottom of the bag. The resultant bag is limited to such closure methods such as the use of a tie wrap, rubber band or other means. By placing a slider closure system on the top edge of the plastic bag, the bag becomes much more versatile, easy to open and close, and the top of the bag retains a linear shape and is not “bunched up” by the closure method.

The plastic slider closure system, installed by the use of double sided pressure sensitive adhesive tape, or a self mating cohesive, removable Velcro type attachment can be applied to other articles as well. These may include tarps, vehicle covers, boat windows, vinyl windows and enclosures. Although plastic slider closures are not typically currently used for heavy duty closures, it is believed that with the use of the method described, more wide spread use of these types of closures will result.

Since zip lock bags are popular for carrying sandwiches and other foods to school and work, the closures of the present invention can be used to allow consumers to fabricate their own resealable bags. These reusable bags can be washed and re-used, allowing a more environmental friendly option than disposable plastic bags.

The method may be useful in other applications whereby bandages, patches or other coverings such as are used in the medical field can be opened and closed without removing the entire bandage or patch.

It is an object of the present invention to provide a slide fastener assembly which has all of the advantages and none of the disadvantages of the prior art relating to zippers, and other closure devices. And to provide a means for attaching plastic slider closures to a range of items.

Accordingly, further objects and advantages of the present invention are:
a) to provide a method of installing a closure assembly whereby the assembly can be easily removed and replaced;
b) to provide a method of installing a “separating” zipper assembly whereby either or both zipper halves can be easily removed or replaced;
c) to provide a zipper with a self-engaging fastening system inherent to the zipper tape;
d) to provide a method of installing alternative fastener methods, such as grommet strips, that can be easily removed, replaced, repaired or changed;
e) to provide a removable means for adjustment in the size or shape of an object, by easily adding or removing fabric segments or bands of different sizes;
f) To provide a means to close or seal both ends or edges of a bag or receptacle
g) to provide a removable means to add pockets, pouches or other receptacles or compartments to an object and maintain the ease of use of a zippered opening;
h) to provide a removable means for access to openings, pockets, or enclosures that is without noise;
i) to provide a removable means for a closure method in any size opening that can be done without force;
j) to provide a means for a closure that does not snag other surface areas;
k) to provide a means for a closure that can align two adjacent surfaces easily and precisely over a long distance;
l) to provide a means increase or decrease the size of an opening to allow or restrict the passage of objects

Additional objects and advantages of the present invention are:
m) to provide a method to easily and quickly change panels in a frame;
n) to provide a method for displaying or reversing opposite sides of a single panel in a frame;
o) to provide a means to interchange zippers in a single garment or item, for a different appearance
p) to provide a means to interchange zippers in a single garment or item, to create an alternative size, shape, or fit;
q) to provide a means to decorate a garment or other article;
r) to provide a means to retrofit items with a removable and repairable zipper or plastic closure assembly;
s) to provide an alternate means of closure in the case of zipper failure by the use of Velcro;
t) to provide a means of quick and easy exit of a zippered enclosure in case of zipper failure;
u) to provide a means of repair for expensive, heirloom, rare, or irreplaceable item that contain zippers;
v) to provide a means of installation and repair on items of complex or complicated design;
w) to provide a means that facilitates quick and easy repair of items in the field

Further objects and advantages of the present invention are:
x) to provide a means to attach flexible, stretchable fabrics in a frame and draw the surface taut
y) to provide an attachment device and method to attach panels in an opening of an outer perimeter structure or frame, with quick deployment and precise alignment;
z) to provide a method for attaching sliding closure assemblies to structures such as metal frames or truss systems;
aa) to provide a method to attach panels or surfaces to rigid frames with the use of sliding closure assemblies

Further objects and advantages of the invention will become apparent from a consideration of the drawings and ensuing description.

### REFERENCE NUMERALS IN DRAWINGS

100 conventional zipper assembly
102 first zipper tape
104 second zipper tape
106 slider with pull tab, or sider
110 cohesive zipper assembly
112 first integral cohesive zipper tape
114 second integral cohesive zipper tape
116 velcro hook or loop or cohesive fastener
118 receptor panel
120 molded slider with integrally extruded interlockable profiled fastener strips
122 molded slider pull
124 first fastener strip
126 second fastener strip
128 first side extruded profile
130 second side extruded profile
132 flexible plastic sheets or panels
135 molded slider with cohesive tapes
136 pressure sensitive adhesive
137 molded slider assembly with pressure sensitive adhesive tapes
138 releasable cover for pressure sensitive adhesive tape
140 fabric shroud or barrier
142 side or end panel
144 corner panel
146 cover flap or fly
150 border assembly
152 removeable outer band
154 perimeter frame
156 changeable panel

### DRAWING FIGURES

The foregoing features of this invention, as well as the invention itself, may be more fully understood from the following description of the drawings in which;

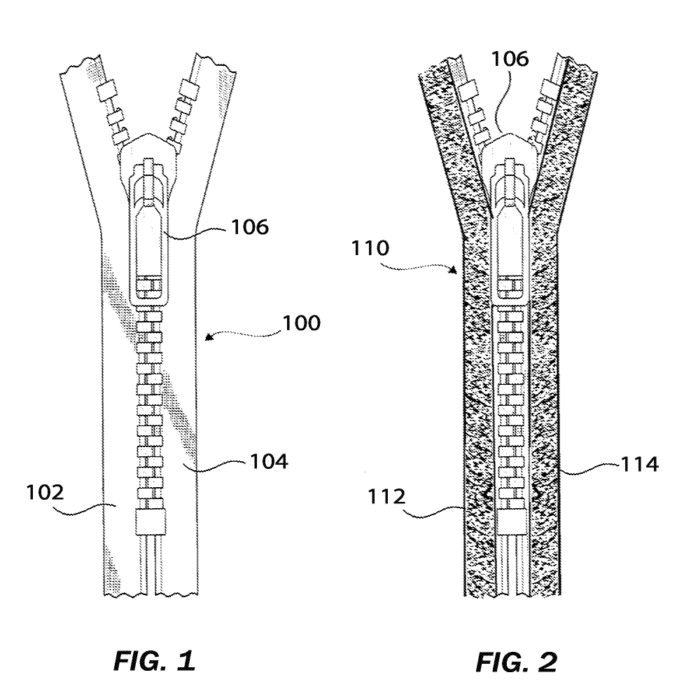

FIG. 1 shows a conventional slide fastener assembly, or zipper.

FIG. 2 shows a zipper with one part of a cohesive closure as a part of the zipper assembly.

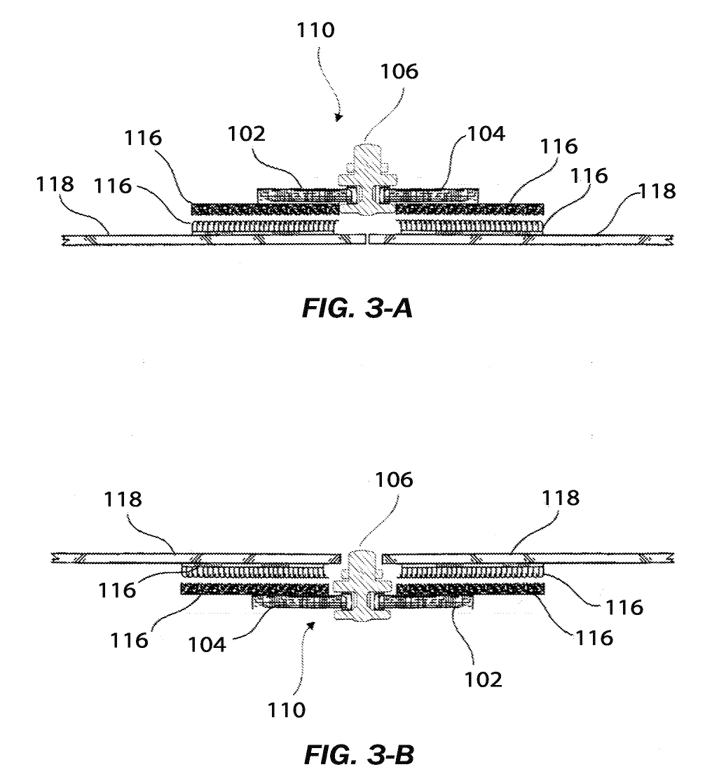

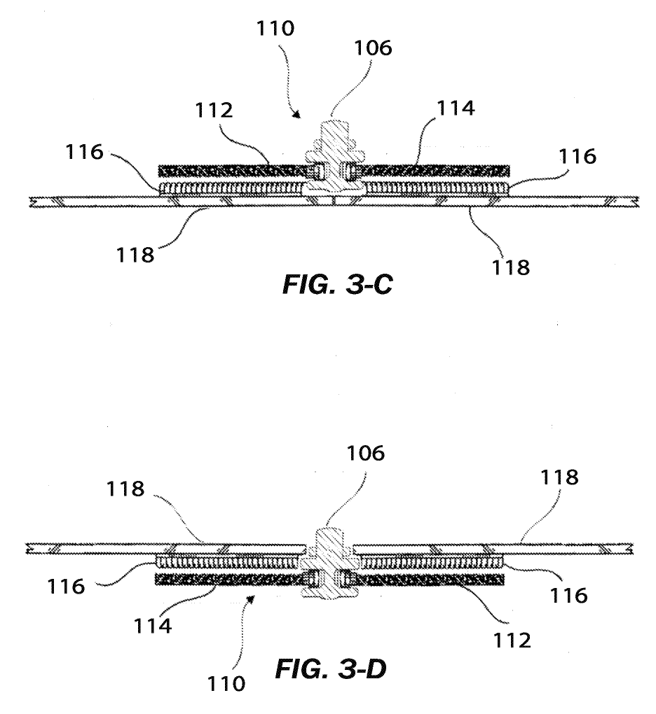

FIGS. 3-A, 3-B, 3-C, and 3-D are multiple fragmentary sectional views from the top of two changeable panels which are engaged to one another by alternative embodiments of the zipper assembly of FIG. 2.

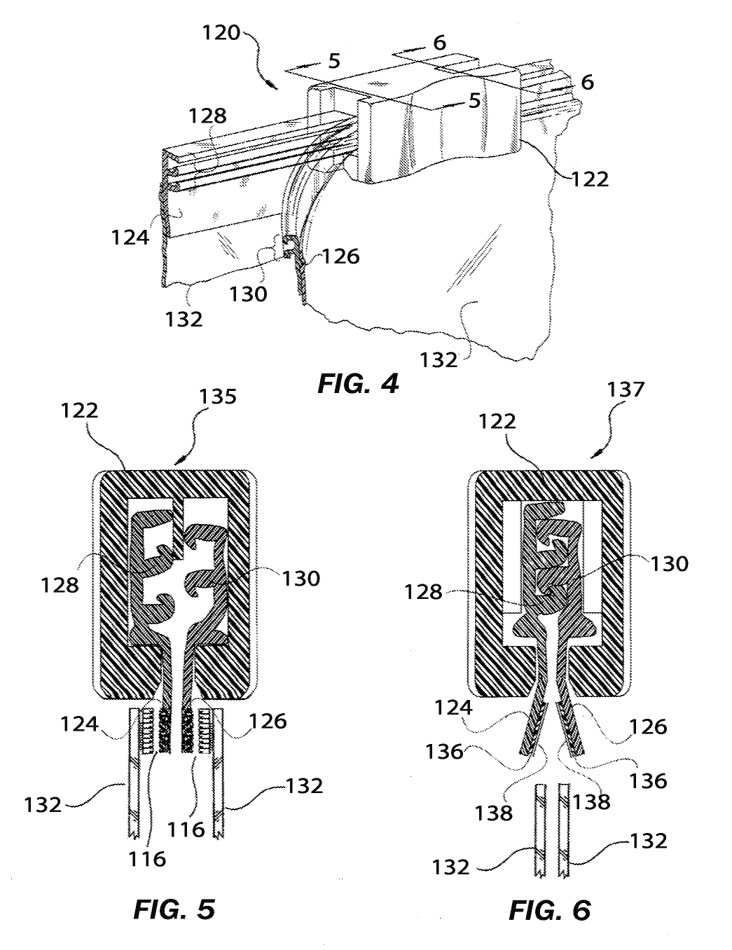

FIG. 4 is a perspective view of a conventional plastic closure system with plastic zipper and slider.

FIG. 5 is a cross sectional view of a closed profile of the plastic closure and slider taken along line 5-5 of FIG. 4.

FIG. 6 is a cross sectional view of an open profile of the plastic closure and slider taken along line 6-6 of FIG. 4.

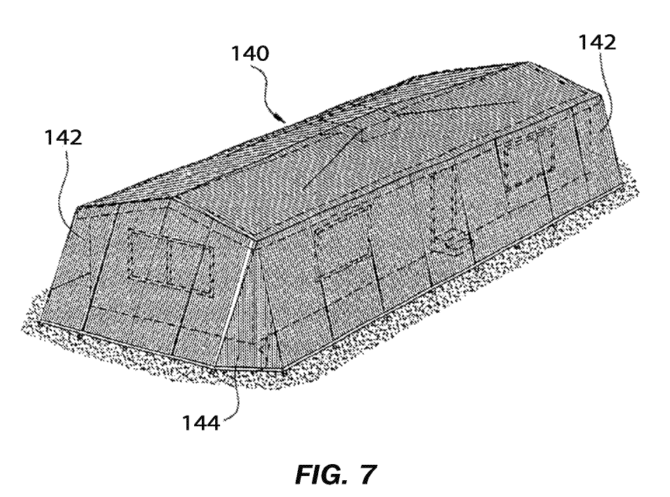

FIG. 7 shows a structure incorporating a protective storm shield or barrier utilizable with the present invention.

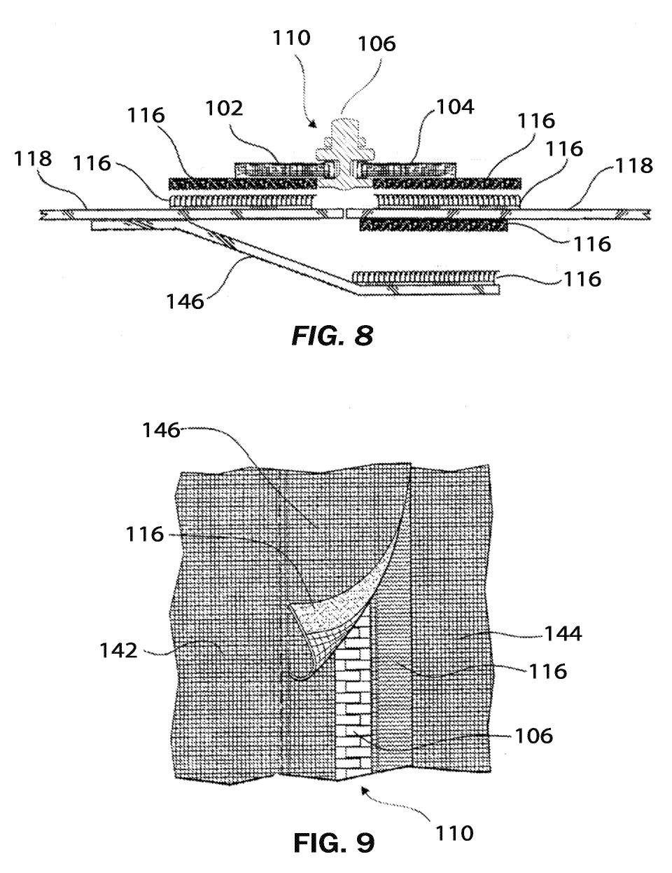

FIG. 8 shows a fragmentary sectional view as viewed from the top of two changeable panels joined to one another in deployed position as part of a storm shield, and with a cover flap or fly over the joint between panels.

FIG. 9 illustrates a fragmentary front view of two changeable panels deployed and joined along adjacent edges, and also shows a cover fly over the joint between panels.

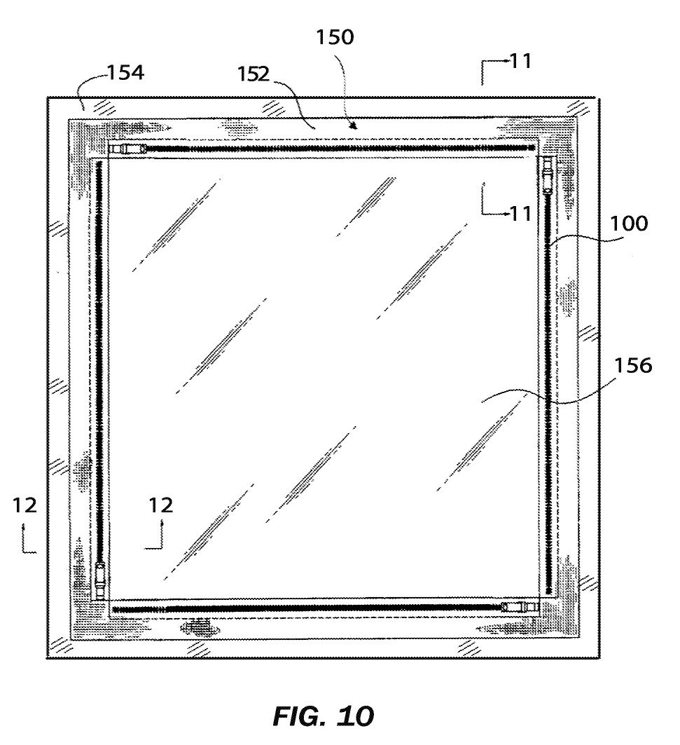

FIG. 10 shows a front elevation view illustrating a deployed changeable panel releasably secured to a frame, in accordance with another embodiment of the present invention.

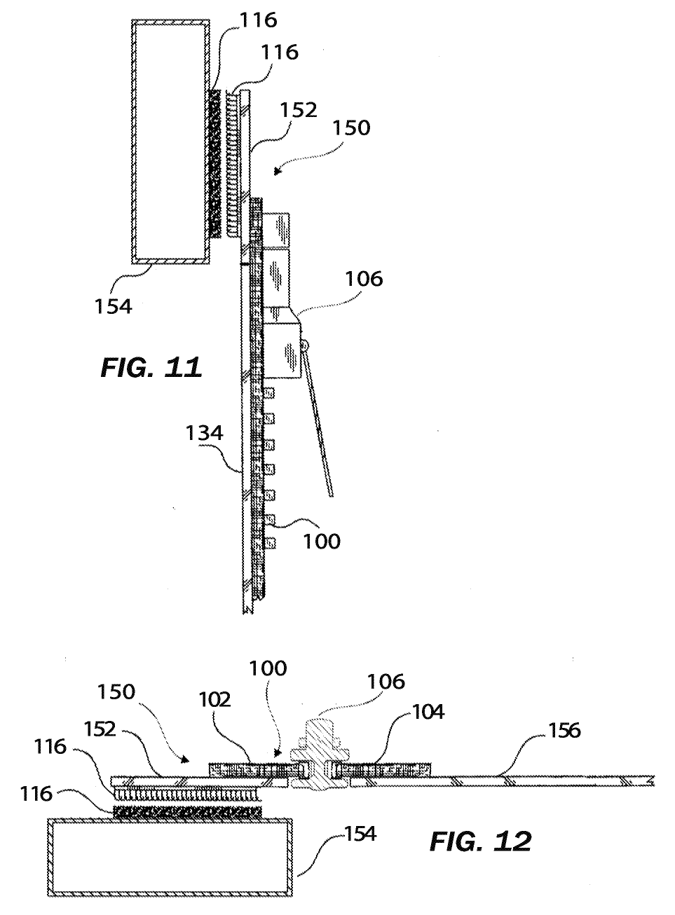

FIG. 11 is a cross-sectional view as viewed along the line 11-11 in FIG. 10.

FIG. 12 is a cross-sectional view as viewed along the line 12-12 in FIG. 10.

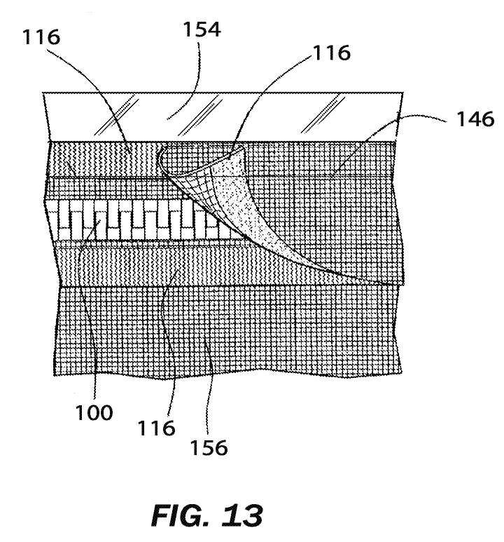

FIG. 13 illustrates a fragmentary front view of a changeable panel in deployed position in a frame, and also shows a cover fly from frame covering zipper connection.

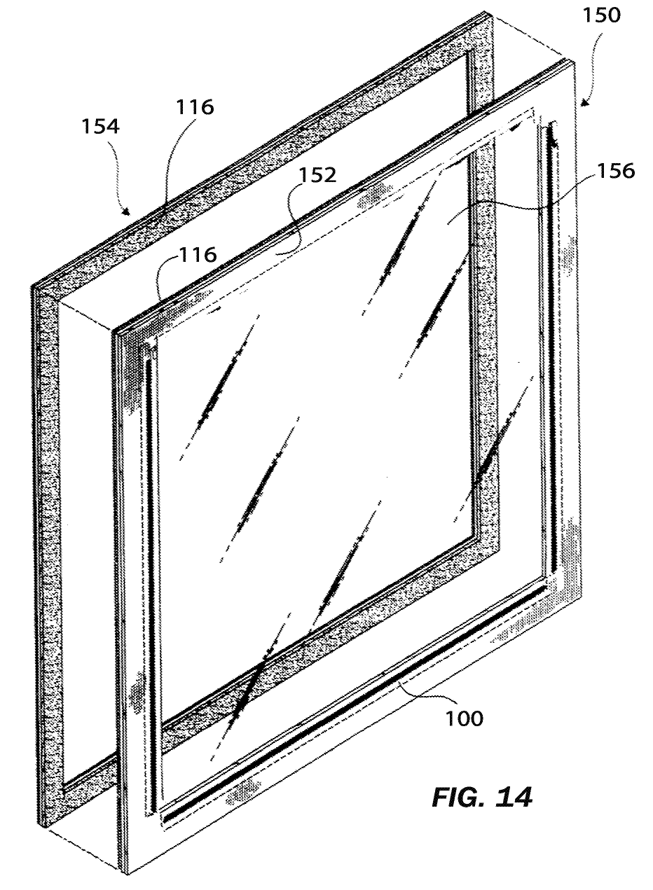

FIG. 14 is an isometric view of the present invention in deployed position.

Reference will now be made to the drawings in which similar elements in different drawings bear the same reference numerals.

### DESCRIPTION

### FIGS. 1 to 14

Referring now to the preferred embodiment of the drawings, wherein the drawing views are for the purpose of illustrating preferred embodiments of the invention only, and not for the purpose of limiting the invention.

FIG. 1, shown is a top plan view of a portion of a form of a conventional slide fastener known in the art as a closed end zipper. It should be understood that there are a plurality of forms of conventional zipper assemblies, such as but not limited to separating zippers, two way zippers, and invisible zippers.

A typical conventional zipper assembly 100 includes a pair of elongated slide fastener strips, flanges, or tapes 102, 104, each tape having a row of fastener elements or teeth in the form of slide fastener coils or interlocking teeth fastened thereto.

A slider with pull tab 106 is slidably positionable on the rows of fastener teeth to selectively secure together the rows thereof. Inside the slider is a channel that accepts and meshes together or separates the opposing rows of teeth, depending on the direction of the slider's movement.

Typically the bulk of a zipper consists of two strips of fabric or plastic tape, each affixed to one of the pieces to be joined, carrying from tens to hundreds of metal or plastic teeth.

The present invention comprises elements shown in the conventional zipper assembly of FIG. 1 or any zipper or slideably positionable recloseable type assembly. When fastened in place on an article, the present invention serves to slideably engage or disengage interlocking teeth, coil, or plastic engageable elements in a manner of operation such as but not limited to that of any conventional zipper taught in prior art, or one similar to such a conventional zipper, but which uses a molded plastic seal that slides closed along the seal similar to the mating surfaces on a Ziploc bag.

The main embodiment of this invention is novel because it teaches reliable means for providing such an interchangeable zipper assembly that may be quickly and economically, in whole or in part, detached from the article it is affixed to, and replaced by another such that the article reliant upon the zipper for fit, closure, or seal becomes completely operable again with a functional zipper assembly.

A conventional zipper 100 is improved and becomes novel as is simply illustrated by the drawing of the device shown in FIG. 2. A separating cohesive tape such as but not limited to Velcro, or a self engaging tape which employs alternating rows of nylon hook and loop, or any self engaging material such as but not limited to magnetic tape or static cling vinyl tape or removable pressure sensitive adhesive is attached or applied to tapes 102, 104 of FIG. 1 by means such as but not limited to sewing or laminating in order to create a cohesive zipper assembly 110. The resultant embodiment is shown in plan view in FIG. 2. The present invention also includes means such as painting or dipping for coating tapes 102, 104 with a liquid formulation wherein the associated compounds harden or congeal into a surface such that tapes 102, 104 shown in FIG. 2-10 will adhere to another cooperating cohesive surface when pressed together. The means for attaching Velcro to zipper tapes 102, 104, or coating tapes 102, 104 to achieve the desired cohesive surface, can be utilized to cover any of the tape 102, 104 surfaces, frontside or underside; and either or both sides adjacent to slider with pull tab 106 to construct a zipper assembly 110.

A further aspect of the invention comprises a first integral cohesive zipper tape 112 and a second integral cohesive zipper tape 114 that are specifically manufactured for the purpose of the present invention, wherein any included compounds are formulated such that the resulting surface of the tape inherently takes the form of a cohesively cooperating surface such as but not limited to Velcro hook or loop or any self engaging material. In this aspect, tapes 112,114 are produced by means such as but not limited to molding, press forming, extruding, or weaving by the manufacturer, wherein any type of teeth or seal, such as but not limited to plastic or metallic interlocking teeth, or plastic-molded coil, or formed interlocking ridges suitable for use with a slider or molded slideably closed seal, can be attached to or made an integral part of tapes 112, 114.

Zipper assembly 110 can be any length, color, shape, weight, or composition as deemed best suitable for the use at hand, such as but not limited to a shape or color that can be utilized for following the contours of an arched tent entry door, or joining decorative swirls of fabric together to create an innovative design, whether rigid, flexible, stretchable, pliable or any other consistency.

When tapes 112, 114 of zipper assembly 110 as shown in FIG. 2 or any variation of such zipper assembly 110, which includes the cohesive closure material as described, is pressed together with cooperating tape applied parallel and adjacent to the edges of objects to be joined, the resultant placement of zipper assembly 110 becomes securely fixed, but is easily removable and replaceable if zipper assembly 110 were to be damaged and rendered inoperable for any reason. This variation of the traditional zipper allows the end user to inexpensively salvage many articles that otherwise may have been discarded because of the difficulties or complexities previously faced in repairing common zipper closures as known to prior art.

FIGS. 3-A, 3-B, 3-C, and 3-D all show a fragmented view, looking down on the joint from above, of some of the alternative combinations and aspects available for installing the zipper assembly 110 of the present invention on surfaces to be joined or engaged, whereby whether the zipper is intended to be closed-ended, open-ended, separating, or invisible, it can be removed and replaced if damaged.

FIG. 3-A illustrates the joining of any type of adjacent panels 118 with one aspect of the present invention such that the zipper assembly 110 is comprised of Velcro loop tapes 116 attached to the a surface of zipper tapes 102, 104 alongside slider 106, and on underside of tapes 102, 104 as relative to the pull tab on slider 106.

Corresponding cooperating cohesive Velcro hook or loop or cohesive fastener 116 is applied along the face of the edge to be joined on either the front or rear, or both surfaces of each panel 118. When cohesive fastener 116 of zipper assembly 110 is pressed into place with cooperating cohesive fasteners 116 on 118, zipper assembly 110 becomes firmly adhered and offers all the typical features of any conventionally attached zipper assembly, as regards partly or fully slideably connecting or disconnecting panels 118.

FIG. 3-B illustrates the joining of adjacent panels 118 with zipper assembly 110 such that the cohesive fastener 116 is attached alongside slider 106 on the front surface of zipper tapes 102, 104 relative to pull tab 106.

In FIG. 3-C a further aspect is shown, in which the inherent features of any cohesive cooperating closure tape are impregnated or extruded or molded or otherwise formed or woven directly into zipper tapes 112 and 114, such that the zipper teeth are fused or molded, or crimped into place directly on or into the tapes. Tapes 112, 114 can then be inserted into the channel of slider 106 such that the inherent cohesive surface can face to the front side, such as shown in FIG. 3-C, or to the underside, as shown in FIG. 4-C, or can be on both front and underside surfaces of zipper assembly 110 if demand were to require producing such tapes double sided.

For the aspects of the invention shown in FIG. 3-A, 3-B, 3-C, or 3-D complete zipper assemblies 110 can be designed and manufactured by those trained in the art. Such assemblies can be utilized as though they were conventional zipper assemblies, except that they have the built-in or attached tapes 112, 114 of the present invention, and are ready for use for any type of garment or bag, or article employing a zipper, to be pressed in place on any panels that are supplied or fabricated, or woven with corresponding cooperating tapes applied. The aspects shown in FIGS. 3-C and 3-D of the present invention, with the cohesive features impregnated or molded or extruded directly into tapes 112, and 114 of zipper assembly 110 further facilitate mass production which can lower costs and affordably provide inventory of replacement zipper assemblies of any size, shape, or color on store shelves worldwide.

Replaceable zipper assembly 110 can be modified from a conventional zipper or manufactured specifically for the purpose of the present invention for use for many different applications, such as but not limited to the typical use for opening or closing openings in garments, fastening separate flexible panels together to form a shroud or protective barrier over structures and equipment, or making air tight and watertight zippers for securing openings in space suits or wet suits.

Referring now to FIG. 4, shown is a conventional plastic molded slider 120 with integrally extruded interlockable profiled fastener strips such as is typically used for a sealed plastic bag. Fastener strips 124 and 126 are extruded to form profiles 128 and 130. When slider 120 is drawn closed by the molded slider pull 122, the first side extruded closure elements of profile 128 are interlocked with the corresponding extruded second side elements of profile 130. A pair of flexible plastic sheets or panels 132 are attached to strips 124 and 126. When engaged, profiles 126 and 128 remain interlocked when the zipper is closed, thereby forming a seal. The seal advantageously is such that under normal conditions of use it forms a barrier to air, vapor, or liquids. It should be appreciated that although such a seal is advantageous, it is not essential to the construction or operation of the present invention and the description herein of such a seal is not intended to limit the features in any way.

The cross sectional view of FIG. 5 illustrates extruded profiles 128, 130 unlocked and in the open position. As slider pull 122 is drawn along the opening, the interlocking closure elements of profiles 128, 130 are engaged as shown in FIG. 6.

Numerous variations of such molded plastic zipper closures are taught in prior art. FIG. 5 further illustrates a novel embodiment of the present invention which transforms slider 120. A conventional slider 120 is improved and becomes novel as is illustrated by the drawing of an improved slider 135 shown in FIG. 5. A cohesive tape such as but not limited to Velcro, or a self engaging tape which employs alternating rows of nylon hook and loop on the same surface is attached or applied to a first side fastener strip 124 and a second side fastener strip 126. The preferred embodiment illustrates a cohesive surface fused or molded directly into the surfaces of strips 124, 126. However, the same results can be achieved by laminating cohesive tapes to the surfaces of tapes 124, 126, whereby a slider 135 is created, such that strips 124, 126 will removeably adhere to cooperating cohesive surfaces on panels 132 when the cohesive surfaces are pressed together. Panels 132 of any size or shape of material of any thickness or weight, such as but not limited to plastic films, vinyl or fabric, and rigid surfaces can be removeably attached to slider 135, whereby two panels may be joined together such that they can be quickly disengaged with the zipper. One skilled in the art will be able to engineer profiles and components for slider 135 to suit an unlimited number of applications, from small thermoplastic bags to large panels. If for any reason slider 135 needed to be replaced, such as if it were to fail, or a different color zipper were desired, slider 135 can be exchanged by peeling cohesive tapes 124, 126 apart from sheets or panels 132 and pressing another slider 135 in place.

A molded slider 137, illustrated in FIG. 6, shows another embodiment of the present invention.

In this embodiment a pressure sensitive adhesive 136 of any suitable composition or tack, whether with a liquid carrier or solid form, is applied on strips 124 and 126 of slider 137 by means such as but not limited to coating or laminating. The pressure sensitive adhesive is covered by a removable paper 138 or layer of any type such that it can easily be peeled to expose the adhesive, whereby zipper assembly 137 with pressure sensitive adhesive 136 on tapes 124, 126 can be adhered to panels 132. In this embodiment, Panels 132 of any size or shape of material of any thickness or weight, such as but not limited to plastic films, vinyl or fabric, and rigid surfaces can be removeably attached to slider 137, whereby two panels may be joined together such that they can be quickly disengaged with the zipper. One skilled in the art will be able to engineer the correct profiles and components for slider 137 to suit an unlimited number of applications. For example, supplied as a consumer product, a slider 137 may be attached to an open bag of snacks to quickly form a seal. Once the bag is sealed, it can be opened and reclosed as desired so the contents remain sealed and fresh.

It should be appreciated that the zipper assemblies depicted in the drawings herein are purely exemplary and their structures have been disclosed in detail with no intent to limit the scope of the present invention to these specifically disclosed structures. For example the zipper assemblies disclosed herein do not require that a zipper pull as shown in the different drawings be used. Zipper pulls of different size or shape may be employed provided that the matching zipper strips or tapes are suitably designed to be actuated by such zipper pulls.

Sliders 135, 137 may be made in multiple parts and welded together or the parts may be constructed to be snapped together. Sliders 135, 137 may also be of one piece construction. The sliders may be made using any desired method, such as but not limited to injection molding. The sliders can be molded from any suitable plastic, such, for example, as nylon, polypropylene, polystyrene, acetal, toughened acetal, polybutylene terephthalate, high density polyethylene, polycarbonate, or ABS. The sliders can be clear, opaque, or colored.

In an embodiment of the present invention, FIG. 7 shows a fabric shroud or barrier 140 for enclosing and protecting structures or equipment from winds and flying debris typically occasioned during a hurricane. As is disclosed and detailed in prior art, barrier 140 is predominantly fabricated in the factory, but in any case at least one or more of the elements must be closed and secured at the site in order to complete the enclosure. More specifically, as shown in FIG. 7, barrier 140 is typically pre-fit such that when it is deployed over an item to be protected, integral side and end panels 142 are prepared with closure methods which include zippers for connection with closeable corner panels 144 in order to create a complete and secure enclosure and completely envelop the structure.

As is further illustrated in FIG. 8, cohesive zipper assembly 110 facilitates a quick and secure fastening of all the panels. In this aspect, changeable or matching panels may be easily fit edge to edge and connected directly to one another.

During the manufacturing process for barrier 140, zipper assembly 110, with cohesive fastener 116 attached to zipper tapes 102, 104 is pressed together with cooperating cohesive tape 116 attached parallel with the edges of panels 142, 144 as they are placed edge to edge. The panels 142, 144 are then disconnected by pulling the tab on zipper slider 106 to release the engagement. At time of deployment panels 142, 144 can be quickly engaged by connecting zipper halves and pulling slider 106 closed to complete the enclosure.

Quick and economical replacement of the zipper assembly 110 can be implemented at the site if the zipper is damaged during deployment so the protection can be secured before the bad weather creates damage to the structure. By simply pulling the zipper assembly from the cooperating cohesive Velcro and pressing another zipper assembly in place, the panels can quickly be connected.

FIG. 9 shows a partial front view of the connection between panels 142 and 144. Slider 106 of zipper 110 is closed and is holding panels 142 and 144 together.

If desired for further connection strength, or to conceal the zipper, a cover flap or fly 146 as shown in FIGS. 8 and 9 collectively can be utilized. In this example fly 146 with cohesive fastener 116 applied parallel to the longitudinal edge of fly 146 is attached to panel 142 by a means such as but not limited to sewing or gluing. A cooperating cohesively fastener 116 is attached on the front of panel 144 parallel and adjacent to zipper assembly 110, such that when the fly is pressed firmly in place mating cohesive fasteners 116 with each other, a cover is fastened in place that can strengthen the zipper connection as well as make it water tight if necessary.

In other embodiments, interchangeable zipper assemblies utilizing static cling or magnetic tapes, or removable pressure sensitive adhesive can be applied directly to a cooperating surface. For example a fabric sign panel may utilize a first zipper half sewn around the perimeter of the sign panel, to connect to a second zipper half comprised of zipper tape with an attached layer of static cling vinyl. The resultant assembly can be applied and aligned as desired on a window glass. When it is desired to change the sign banner, the banner can be unzipped and quickly replaced with another without disturbing placement or alignment on the window glass.

An interchangeable zipper assembly can serve many purposes, such as but not limited to replacing a damaged inoperable zipper such that the article reliant upon the zipper is not rendered useless, facilitating exchanging one or both panels to which the zipper is attached in order to satisfy a functional or designer need, or simply changing zipper color, texture, or pattern at a whim to implement a desired change in appearance.

Referring to FIG. 10, another preferred embodiment is shown utilizing a removable outer band 152 in conjunction with a zipper assembly 100. A detachable band assembly, generally designated as border 150, bridges or spans a connection between a changeable panel 152 and a predetermined perimeter frame 154, wherein border 150 serves to retain panel 156.

The same assembly and deployment is shown in FIG. 14 in isometric view, which illustrates the manner in which border 150 is attached to cohesive fastener 116 that would be permanently attached to frame 154.

Border 150 can be deployed and fastened in place within any type of frame 154. Aside from facilitating a relatively inexpensive replacement if zipper assembly 100 is damaged, quick deployment with automatic alignment of changeable panel 156 is facilitated by the present invention.

Border 150 is comprised of band 152 which can be any pliable, stretchable, or rigid material of any suitable thickness, such as but not limited to fabric, metal, or neoprene and can be comprised of one layer, or laminated from multiple layers. It is typically constructed by cutting longitudinal elements to fit the selected frame type and size, and joining those elements at each end by means including, but not limited to sewing, gluing, or hingeably connecting, such that border 150 can be foldable.

More specifically, it will be seen in FIGS. 11 and 12 that band 152 is attached to frame 154 with a fastener option that will allow the entire border 150 to be removed from the frame 154 if necessary. The preferred fastener for this attachment point would typically be cohesive fastener 116 with corresponding and cooperative cohesive fastener 116 applied to frame 154. However, other fastener options for removably connecting border 150 to frame 154 may include but are not limited to bungee ties or rope with grommets, or nut/bolt fasteners. Fasteners will vary depending on the assembly method and materials of frame 132 and the size, weight, and characteristics of panel 156. Typically, one skilled in the art will determine fastener choice as part of the product design.

Zipper assembly 100 of the preferred embodiment as shown in FIGS. 11, 12 is collectively utilized as a series of separating zippers. First zipper tape 102 of zipper 100 is attached along the face of each longitudinal element of band 152 around and adjacent to the inside edges of its opening.

Second zipper tape 104 of zipper 100 is attached around the perimeter of panel 156. The preferred changeable panel 156 for the present invention is flexible and stretchable. However, panel 156 can be of any material or consistency or size that one skilled in the art may need to quickly deploy for an event or series of events and subsequently remove. If panel 156 is stretchable, one skilled in the art applies second zipper tape 104 to panel 156 in a manner that compensates for the stretch such that the panel will be drawn taut along all sides as it attaches to border 150.

Border 150 is designed and constructed to precisely fit the desired type of frame 154 and corresponding panel 156 combination. It should be understood that border 150 is first attached to frame 154 without bearing panel 156. This allows border 150 to be precisely positioned as desired without any stress or tension related to stretch or weight from panel 156. After border 150 is in place and aligned around the frame, panel 156 can then be quickly secured to border 150, or removed at will.

Fit and engagement are accomplished by connecting zipper 104, attached around the perimeter of panel 156, with zipper 102 attached around the inside of band 152. Once connected to border 150, panel 156 will be drawn taut within the opening of frame 154. Because zippers 102, 104 match in length with each other along each corresponding edge of border 150 and panel 156, panel 156 is deployed taut, smooth, and symmetrical and is pleasing to the onlooker, as needs to be the case with panel 156 which may be intended as a projection surface or sign panel, for example.

The preferred frame 154 for the present embodiment is inflatable. However, from a structural standpoint there are no material or construction method constraints that need be applied to selecting frame 154, which can consist of any enclosure, wall, formation, or free standing element containing a fenestration or opening of any desired size and shape suitable for deployment and support of any type of changeable panel 156. Frame 154 can be fixed in place and permanent, or collapsible and portable. Frame 154 can completely surround an opening or be as simple as a typical realty yard sign, with a vertical post connected to a perpendicular arm.

One skilled in the art can select a proper frame 154 to correspond to the weight, dimensions, and characteristics of a selected panel 156.

At any time panel 156 can be quickly unzipped from border 150, and stored as necessary for quick deployment for future use. If desired, another panel 156, pre-fit for the same frame 154, but perhaps of a different material, color, or pattern can be quickly deployed in frame 154.

Although border 150 is removable from frame 154, it is preferable that it always remain in place. However, if zipper 102 attached to band 152 were ever to be damaged, border 150 can be easily detached from frame 154 for repair or replacement. A new or repaired border 150 can be quickly reinstalled in the field.

In some cases a rigid or non stretchable panel 156 would be used. A stretchable border 150 might be necessary in order to pull tightly and create tension evenly around rigid panel 156. In this configuration, border 150 can be stretched between frame 154 and panel 156 to attach zippers 102 and 104. As zippers 102 and 104 are drawn together by slider 106, panel 156 is pulled tight, with even tension from all angles within the frame.

If such rigid panel 156 were to be heavy such that it might cause the top of stretchable border 150 to stretch too much in an upright frame 154, such that panel 156 may sag or appear loose at the top, a cover flap or fly of any non-stretchable material, such as but not limited to canvas, PVC, or acrylic can be utilized to pull the weight of panel 156 into alignment as necessary. Such a fly would also serve to conceal the zipper if desired, in order to create a more monolithic appearance. If bungee cord or rope were utilized to connect border 150 to frame 154, the finished appearance of the completed deployment of panel 156 would show a gap around the perimeter between border 150 and frame 154. A fly would serve to conceal that gap and the associated unsightliness of the cord or rope, as well as zipper 100.

This detail is shown more specifically in FIG. 13. Fly 146 with cohesive fastener 116 is attached directly to and around frame 154 by connection means such as but not limited to sewing or gluing. Cohesive fastener 116 is attached around panel 156 adjacent to and inside zipper 100 either continuously, or intermittently spaced, such that when cohesive fastener 116 on fly 146 is pressed firmly in place over cohesive fastener 116 on panel 156 it provides a cover that can strengthen the zipper connection, draw panel 156 straight across the top, and conceal all connection points, as well as make the finished deployment water resistant if necessary. Fly 146 can be utilized only across the top, or on any or all sides as may be appropriate for the specific materials, construction and final appearance desired.

If it is not necessary to cover zipper 100, yet it is desired that any gap between frame 154 and border 150 resulting from bungee or rope attachment of border 150 to frame 156 be concealed, fly 146 would cover border 150 only. It may or may not be deemed necessary to utilize a detachable cohesive fastening method to attach fly 146 to border 150, in which case fly 146 would be attached around the outside of frame 154 as shown, and simply loosely drape over and around border 150.

It should be understood that although the preferred embodiment illustrated in perspective in FIG. 14 shows a separate zipper length along each of the four edges to be connected in order to draw panel 156 equally taut from all directions, the connection can also be accomplished with one continual zipper length 100, such as may be required for a circular or oval shape.

Zippers 102, 104 may be attached to border 150 and panel 156 respectively with any attachment method, including but not limited to gluing, sewing, or welding.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

Further, in the absence of explicit language in any method claim setting forth the order in which certain steps should be performed, the method claims should not be construed to require that steps be performed in the order in which they are recited.

### SUMMARY, RAMIFICATIONS, AND SCOPE

Accordingly, the reader will see that the method of the invention provides a highly desirable, effective, economical, user friendly, practical method of zipper or plastic slider closure installation, repair or replacement. The method of the invention may well be used in a multiplicity of products, applications and industries.

The method of the invention discloses how the many advantages of a sliding closure assembly—ease of use, flexibility, and functionality, can be enjoyed without the disadvantage or concern of failure of the closure assembly.

While the above description contains much specificity, the description should not be construed as a limitation on the scope of the invention, but rather as an exemplification of one preferred embodiment thereof. Many other variations are possible. For example, our invention:
a) Allows for flexibility in design and construction of items that were not previously considered for zipper or plastic slider closures;
b) Allows for adding or reducing the size of tarps, partitions, enclosures and other openings that have a need to be variable in size and shape;
c) Allows a way for designers and individuals to change the look of clothing, purses, and accessories with a quick change method;
d) Allows for field repair of items such as space suits, hazmat clothing, and other specialized and costly garments and equipment that incorporate zipper closures;
e) Allows for a method of installing billboard drapes or covers;
f) Allows for a method of repair or refurbishment of upholstered items;
g) Allows for a method of repair or restoration of boat and marine enclosures;
h) Allows for the addition of a separable part of a garment to or from another, as in the conversion between trousers and shorts or the connection of a hood and a coat.

Thus the scope of the invention should be determined by the appended claims and their legal equivalents, rather than by the examples given.

While we believe that many consumers, manufacturers, engineers, inventors, tailors, and designers of clothing, equipment, gadgets and apparatuses will find the method, or variations of the method, desirable for construction, modification, fabrication, as well as repair, retrofit and restoration of items containing closure systems, we do not wish to be bound by this.

1. A slider assembly comprising:
a. interlocking parts;
b. slideable means for engaging and disengaging said interlocking parts;
c. cohesive means for fastening said slider assembly to a predetermined article which has cooperating cohesive parts.

2. The slider assembly of claim 1 comprising:
a. conventional zipper tapes with interlocking elements attached and a slider for moving between a closed position and an open position to engage and disengage said interlocking elements;
b. a tape with cohesive surface attached by connection means to one or a plurality of surfaces of said conventional zipper tapes.

3. The slider assembly of claim 1 comprising:
a. conventional zipper tapes with interlocking elements attached and a slider for moving between a closed position and an open position to engage and disengage said interlocking elements;
b. a layer applied by coating means to one or a plurality of surfaces of said conventional zipper tapes whereby said coating congeals into a cohesive cooperating surface and adheres to said conventional zipper tapes.

4. The slider assembly of claim 1 comprising zipper tapes which are manufactured by molding means wherein integrally inherent cohesive cooperating features are impregnated directly into said zipper tapes;
a. said zipper tapes are further comprised of interlocking elements attached by connection means along one edge of each of said integrally cohesive zipper tapes;
b. a slider for moving between a closed position and an open position to engage and disengage said interlocking elements.

5. The slider assembly of claim 1 comprising zipper tapes which are manufactured by molding means wherein integrally inherent cohesive cooperating features are impregnated directly into said zipper tapes;
a. said zipper tapes are further comprised of interlocking elements formed by molding means directly into and along one edge of each of said integrally cohesive zipper tapes;
b. a slider for moving between a closed position and an open position to engage and disengage said interlocking elements.

6. The slider assembly of claim 1 wherein said slider assembly comprises integrally extruded interlockable profiled fastener strips with ridges and shoulders for holding said interlockable profiled fastener strips on said slider assembly;
a. said fastener strips employ a tape with a cohesive surface attached by connection means to a predetermined space on one or a plurality of surfaces of said fastener strips;
b. a slider for moving between a closed position and an open position to engage and disengage said interlocking elements.

7. The slider assembly of claim 6 wherein the tape with a cohesive surface comprises a pressure sensitive adhesive.

8. The slider assembly of claim 1 wherein said slider assembly comprises integrally extruded interlockable profiled fastener strips with ridges and shoulders for holding said interlockable profiled fastener strips on said slider assembly;
a. said fastener strips each employ a predetermined space with a layer applied by coating means to one or a plurality of surfaces of said conventional zipper tapes whereby said coating congeals into a cohesive cooperating surface and adheres to said fastener strips;
b. a slider for moving between a closed position and an open position to engage and disengage said interlocking elements.

9. The slider assembly of claim 8 wherein said coating is a liquid pressure sensitive adhesive.

10. The slider assembly of claim 1 wherein said slider assembly comprises integrally extruded interlockable profiled fastener strips with ridges and shoulders for holding said interlockable profiled fastener strips on said slider assembly;
a. said fastener strips each employ a predetermined space with integrally inherent cohesive cooperating features formed by molding means wherein said integrally cohesive inherent cohesive cooperating features are impregnated directly into said zipper tapes;
b. a slider for moving between a closed position and an open position to engage and disengage said interlocking elements.

11. The cohesive surface with cooperative connection means of claim 1 selected from the group consisting of Velcro hook and loop, self engaging hook and loop, removable pressure sensitive tape, magnetized tape, and static cling vinyl.

12. The slider assembly of claim 1 containing decorative highlights selected from the group consisting of reflective and non reflective colors, patterns, textures, and prints

13. The slider assembly of claim 1 containing decorative embellishments selected from the group consisting of jewelry, embroidery, appliqués, and charms consisting of glass, metal, and plastic shapes.

14. The slider assembly of claim 1 whereby said slider assembly with said cohesive surfaces can be pressed together with cooperating cohesive parts along the surfaces of each edge of two predetermined panels such that when said panels are joined together at said edges said zipper assembly functions to slideably close and open to engage and disengage the interlocking parts between said panels yet said slider assembly can be peeled at any time to separate from said cooperating parts and interchanged with another similar but potentially different appearing slider assembly.

15. A border assembly comprising:
a. Cooperating fastener means along the outside perimeter edge of said border assembly for attachment to cooperative fastener means on the surface of a predetermined separate frame;
b. A slider connection means along the inside perimeter edge of said border assembly for attachment to a cooperative slider connection means along the outside of a separate predetermined changeable panel.

16. The border assembly of claim 15 wherein the surface adjacent to the outer perimeter of said border assembly comprises a connection means selected from the fastener group consisting of bungee cord and grommets, rope and grommets, cohesive tape, and bolt and nut.

17. The border assembly of claim 16 whereby the outer perimeter of said border assembly is attached by said fastener group to a separate predetermined frame such that said border assembly may be disengaged from said separate frame.

18. The cohesive tape of claim 16 with cooperative connection means selected from the group consisting of Velcro hook and loop, self engaging hook and loop, removable pressure sensitive tape, magnetized tape, and static cling vinyl.

19. The border assembly of claim 15 wherein the surface adjacent to the edge of the inner perimeter of said border assembly comprises a first slider half attached by connection means to said border assembly.

20. The border assembly of claim 17 whereby the inner perimeter of said border assembly is attached by said first slider half to a predetermined separate panel wherein said separate panel employs a second slider half attached by connection means on the surface along the outside perimeter edge of said panel and said second slider half matches said first slider half in length and type of interlocking parts.

21. The panel of claim 18 wherein said second slider half comprises a corresponding zipper tape with a cohesive surface and said cohesive surface is pressed together with a cooperating cohesive surface attached by connection means to said panel.
